(19) United States
(12) Patent Application Publication
(10) Pub. No.: US 2004/0089329 A1
(43) Pub. Date: May 13, 2004

(54) Apparatus for cleaning containers

(76) Inventor: Johannes C. H. Bijster, Obdam (NL)

Correspondence Address: Richard L Byrne, 700 Koppers Building, 436 Seventh Avenue, Pittsburgh, PA, 15219-1818, US

(21) Appl. No.: 10/433,883

(22) PCT Filed: Dec. 12, 2001
(86) PCT No.: PCT/NL01/00905

(30) Foreign Application Priority Data
Dec. 12, 2000 (NL) 1016858

(51) Int. Cl. B08B 9/00; B05B 3/00

(52) U.S. Cl. 134/167 R; 239/227

(57) ABSTRACT

An apparatus for cleaning inner walls of a container, comprising: at least one spray nozzle which is rotatable at least on a first and on a second axis, wherein the first and the second axis enclose an angle; a drive connectable to the spray nozzle for selective rotation of the spray nozzle; and a transmission between the drive and the spray nozzle, wherein the transmission comprises at least two couplings, each of which can be actuated selectively and each of which is associated with one of the axes.

The present invention relates to an apparatus for cleaning inner walls of a container, comprising: at least one spray nozzle which is rotatable at least on a first and on a second axis, wherein the first and the second axis enclose an angle; a drive connectable to the spray nozzle for selective rotation of the spray nozzle; and a transmission between the drive and the spray nozzle.

Such apparatuses are generally known, for instance from the International patent application WO 97/36697. In the known apparatus two motors are used to drive the rotation of the spray nozzle or spray nozzles on two axes enclosing an angle. The spray nozzle is rotated more particularly on a horizontal axis and on a vertical axis. The stated international patent publication relates to alleged control of the two motors independently of each other, each motor being associated with one of the axes to enable each path to be followed. The motors cannot however be controlled independently of each other under all operating conditions and, to the extent that such an independent control is possible, it can only be realized with two very costly and heavy motors, for instance stepping motors.

The present invention has for its object to provide an apparatus for cleaning inner walls of a container which is greatly simplified compared to this known art.

Such an apparatus is further known from the U.S. Pat. No. 3,472,451 in the name of James Orem. The apparatus known herefrom has few possible uses and is inflexible in respect of the control thereof. When setting of cleaning patterns or adjustment thereof is required, this has to take place manually. There is a first central control. In the non-actuated state hereof there is no rotation of the spray nozzle at all. In the actuated state of this central control both rotations take place automatically. Rotation on the substantially horizontal axis can further be adjusted herein by actuating a secondary control, but is not controllable independently of rotation on the vertical axis. In order to achieve this, the secondary control must be deactivated and a third control can be actuated which is connected to a manual drive. This produces a very crude pattern, all the more so because the spray nozzle is usually concealed from the view of a user. The manual operation here provides no advantages whatsoever, but only further uncertainty about the effectiveness of the cleaning process on the container.

An apparatus according to the present invention is distinguished in that the transmission comprises at least two couplings, each of which can be actuated selectively and each of which is associated with one of the axes.

The defining of a path of a point of incidence of a flow of cleaning agent to be generated with the spray nozzles takes place according to the invention by individual control respectively actuating of the separate couplings. The single motor is hereby spared, and can then be actuated continuously and only acts effectively on the spray nozzle or spray nozzles when the couplings are actuated. This in contrast to the known art, where for instance two stepping motors were used which had to be set into or taken out of operation selectively. This is very disadvantageous for the lifespan of such very sensitive stepping motors.

According to the present invention the single and simple motor can be used to bring about both rotation movements on the axes. The configuration is greatly simplified compared to the known art in that very sensitive stepping motors or other methods of driving do not have to be used, but very robust couplings are used to achieve the rotation movement of the spray nozzle on both axes.

In a first preferred embodiment the couplings comprise two coupling parts and are arranged on a single drive shaft, wherein at least one coupling part of each of the couplings is displaceable therealong. This is a particularly simple and robust configuration. The coupling parts can for instance be energized with electromagnetic means to come into mutual contact to actuate the coupling and to bring about the relevant rotation movement of the spray nozzle on the axis associated with the relevant coupling. Additionally or alternatively, use can be made of at least one magnetic field coupling. These have the additional advantage that they are not susceptible to wear, so that the durability is improved. In addition, overload of the drive is hereby combatted effectively. These couplings on the basis of magnetic fields will simply slip in frictionless manner when the load becomes greater than the drive power.

In a further preferred embodiment a gear rack is used to rotate the spray nozzle on a horizontal axis during operation. Using a rotation mechanism the spray nozzle can engage the shaft on the gear rack via a toothed wheel, wherein the shaft is provided with this gear rack. Rotation on the horizontal axis can be effected with an up and downward movement of the shaft. Such a shaft preferably protrudes through an outflow opening during operation. When the shaft is retracted sufficiently far, the outflow opening is left clear and rapid emptying of the apparatus can be effected after completion of the operations for cleaning the inner wall of the container. This is desirable and advantageous in enabling rapid removal and deployment of the apparatus at another location after cleaning of the inner wall of the container has been completed.

Rotation on the second axis, which is for instance vertical in operation of the apparatus, can take place with an associated coupling via a shaft connected to the spray nozzle, wherein the shaft is rotatable round the length direction thereof under the influence of the associated coupling. The two shafts can preferably form a unit. The use of two shafts is not precluded. The spray nozzle can be arranged in a housing which can be rigidly connected to the shaft rotatable on the longitudinal axis thereof, wherein the housing is rotatable with the shaft. Positioning of the spray nozzle via the housing is therefore simple and robust, while the housing co-rotates with the rotation of the shaft and thus carries along the spray nozzle in the rotation movement on the axis which is substantially vertical during operation.

In a further embodiment the transmission can comprise at least one additional coupling which can be selectively actuated and which is associated with one of the axes, which additional coupling is oriented in a direction opposite to that of the coupling associated with the relevant one of the axes. A reversal of the rotation direction on the relevant one of the axes can thus be realized without having to reverse the drive direction of the motor and without at the same time influencing the rotation direction on the other one of the axes.

In a further favourable embodiment at least one of the couplings is a pneumatic or hydraulic coupling. This has the advantage, particularly in environments with fire hazard, that there is no or hardly any risk. A plate coupling or a magnetic field coupling could for instance form a hazard in an environment with flammable substances and gases. This is not the case with a pneumatic or hydraulic coupling.

In a further embodiment an apparatus according to the invention can also have the feature that the first of the couplings is arranged for selective actuating between an upright tube and a shaft extending therethrough, and the other coupling can be selectively actuated to act on the upright tube and wherein the shaft is coupled to the spray nozzle at the spray nozzle via a transmission placed in the upright tube. In such an embodiment the apparatus is easily stopped once the motor is deactivated, and run-on can be prevented. In such an embodiment the relative movement of the upright tube and the shaft relative to each other in a manner of speaking also defines the relative movement through which the spray nozzle passes. When the upright tube and the shaft both rotate, rotation of the spray nozzle on a first axis takes place, while if only the shaft rotates the transmission converts this into a rotation movement of the spray nozzle on the other axis.

The invention will be further described hereinbelow with reference to a description of the annexed drawings, in which:

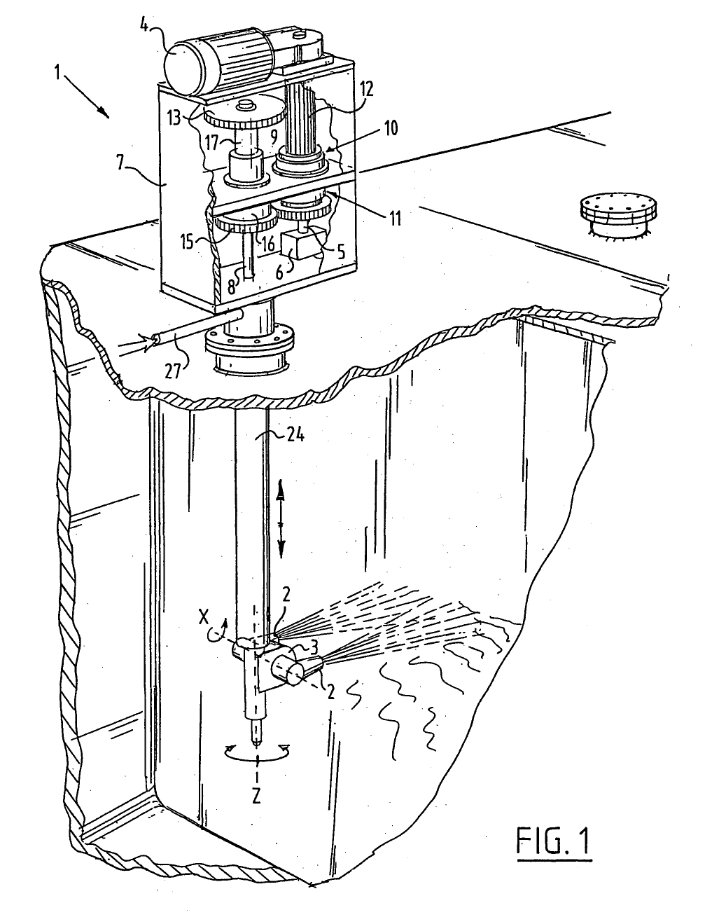

FIG. 1 shows a partly cut-away, perspective and schematic view of an apparatus according to the present invention;

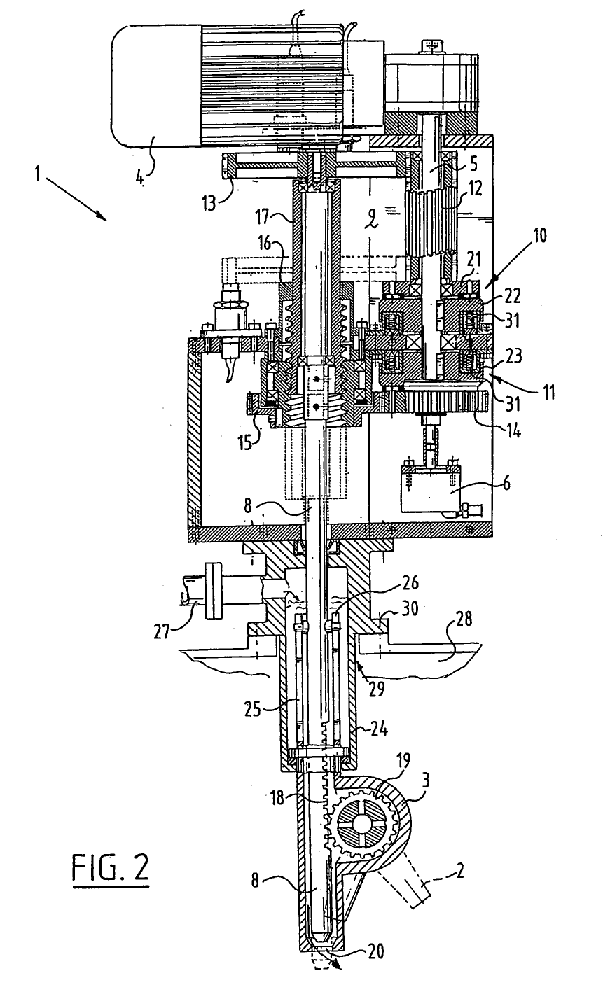

FIG. 2 shows in cross-section a view corresponding with FIG. 1 of the first embodiment of an apparatus according to the present invention;

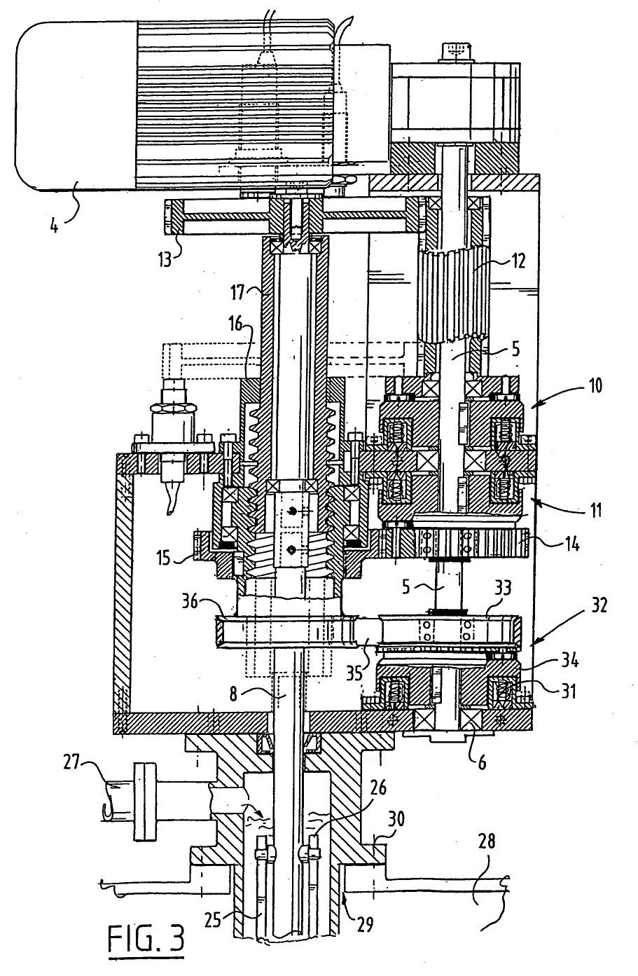

FIG. 3 shows a view similar to FIG. 2, although of a second embodiment of an apparatus according to the present invention;

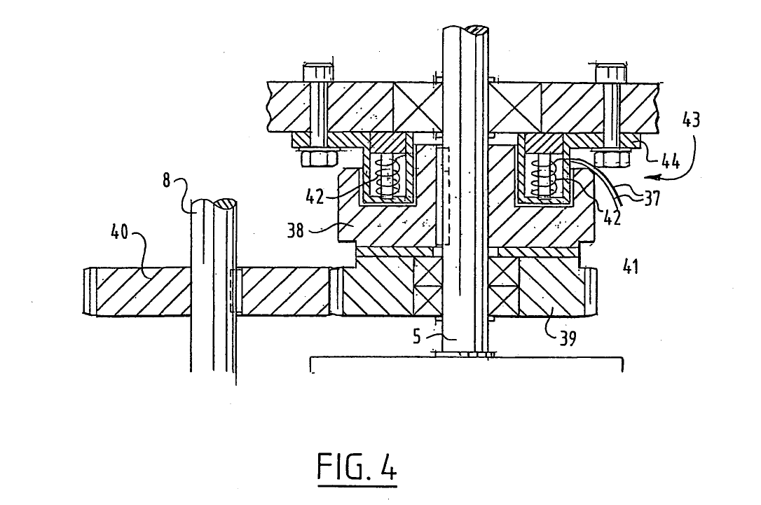

FIG. 4 shows a side view in cross-section of a magnetic field coupling preferably applied in an apparatus according to the present invention; and

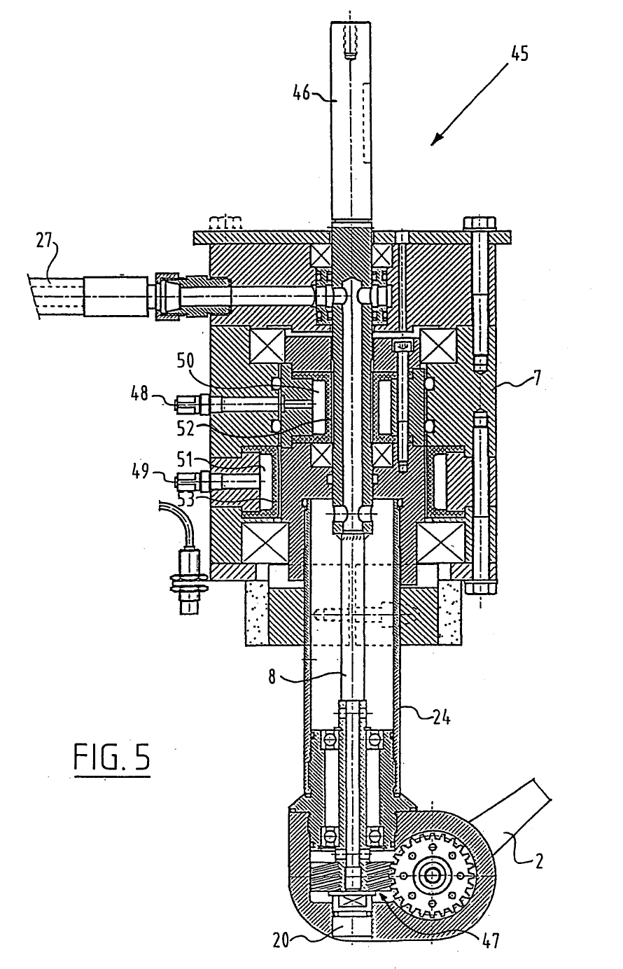

FIG. 5 shows a view similar to FIGS. 2 and 3, although of a third embodiment of an apparatus according to the present invention.

In the drawings and the description thereof following hereinbelow the same or similar parts and components are designated with the same reference numerals.

FIG. 1 shows a partly cut-away, perspective, schematic view of an apparatus 1 as first embodiment of an apparatus according to the present invention. In the embodiment shown here the apparatus 1 comprises two spray nozzles 2 which are rotatable on a common horizontal axis designated with X. Spray nozzles 2 are mounted on a housing 3 for rotation on the horizontal axis X, and housing 3 is rotatable on a substantially vertical axis designated with Z.

The driving of spray nozzles 2 on the substantially horizontal axis X and of housing 3 on the substantially vertical axis Z is realized in the manner described below.

As shown in FIG. 1 and in FIG. 2, apparatus 1 comprises a drive designed as a motor 4 with which during operation a drive shaft 5 is driven. Drive shaft 5 is engaged by motor 4 on one side and extends into a bearing block 6 on the other. Motor 4 is placed on a gearbox 7 in which the drive shaft 5 extends, as does a shaft 8 which extends from gearbox 7 to spray nozzles 2.

The transmission 9 between drive shaft 5 and the shaft 8 extending to spray nozzles 2 comprises a first coupling 10, which is associated with rotation on axis Z and can be selectively actuated, and a second coupling 11, which is associated with rotation on axis X and can likewise be selectively actuated. In the actuated state of the first coupling 10, which is associated with rotation of spray nozzles 2 on axis Z, the shaft 8 is rotated radially round the longitudinal direction thereof. In the actuated state of the first coupling 10 a pinion 12 co-rotates with drive shaft 5 and transmits the rotation movement of drive shaft 5 onto toothed wheel 13, which is fixedly coupled to shaft 8. The rotation movement of drive shaft 5 is therefore also transmitted to shaft 8 which, as shown in FIG. 2, is coupled rotatably to housing 3, so that housing 3 with spray nozzles 2 thereon is carried along in the rotation movement of shaft 8. In the non-actuated state of first coupling 10, pinion 12 remains at rest and shaft 8 does not rotate.

In the actuated state of the second coupling 11 the toothed wheel 14 is co-displaced in the rotation movement of drive shaft 5. Toothed wheel 14 engages a counter wheel 15 which rotates in a direction opposite to that of toothed wheel 14. A bush 16 with internal screw thread as shown in FIG. 2 is mounted fixedly on counter wheel 15, wherein a threaded spindle 17 with external screw thread is mounted fixedly on shaft 8. As shown clearly in FIG. 2, when the second coupling 11 and toothed wheel 14 are rotated in the actuated situation the counter wheel 15 is driven so that the bush rotates therewith, and the threaded spindle 17, which is mounted fixedly on shaft 8, is moved up and downward. Pinion 12 and toothed wheel 13 do not herein lose contact with each other because of the longitudinally toothed outer surface of pinion 12, so that toothed wheel 13 and thereby the shaft 8 can be driven in a rotation movement on vertical axis Z irrespective of the height position occupied by shaft 8.

When toothed wheel 15 rotates in the actuated state of the second coupling 11, the shaft moves up or downward depending on the rotation direction of drive shaft 5. As shown in FIG. 2, shaft 8 is provided with a gear rack 18 and spray nozzles 2 are fixedly mounted on a toothed wheel 19. During the up or downward movement of shaft 8 the gear rack 18 engages the toothed wheel 19 to pivot the spray nozzles 2 respectively downward and upward on the substantially horizontal axis X.

Couplings 10 and 11 can be set into and taken out of operation individually. This has the result that spray nozzles 2 can rotate on both axes X and Z, one of the two axes X or Z and neither of the two axes X and Z.

FIG. 2 also shows that on the lower outer end thereof the shaft 8 extends through an outflow opening 20 of housing 3 in a normal operating position thereof. When shaft 8 is moved sufficiently far upward in the actuated state of the second coupling 11, the outflow opening 20 is left clear. This enhances a rapid emptying of the system when its operation is completed. The situation of the spray nozzle drawn in broken lines does not necessarily correspond to this retracted position of shaft 8; this is a schematic view.

In order to increase the stability of shaft 8, even when it is withdrawn from outflow opening 20, there is arranged in the interior of an upright tube 24 a bracket 25 which engages the shaft 8 slidably on the upper side 26 of the bracket. In the embodiment shown here the bracket forms an extension into upright tube 24 from housing 3.

The supply of cleaning liquid takes place via a feed line 27 which is connected to the interior of upright tube 24. Through bracket 25 there is a passage for the cleaning liquid to the interior of housing 3 and subsequently to spray nozzles 2, so that a flow of cleaning liquid can be emitted by spray nozzles 2.

In the embodiment shown in FIG. 1 and in FIG. 2 only the upright tube 24 with housing 3 on the free end thereof extends into the interior of a container 28 for cleaning. These parts of apparatus 1 are inserted through an opening 29, for instance a manhole, wherein flange 30 closes the opening 29 so as to prevent cleaning liquid leaving the container 28.

The first coupling 10 comprises a first coupling part 21 connected fixedly to pinion 12 and a second coupling part movable to and from the first coupling part 21 along drive shaft 5. The second coupling part 22 contains coils 31 for electrical energizing which, under the influence of electromagnetic forces, press the second coupling part 22 against the first coupling part 21 in order to actuate the coupling 10. The control of the coils and the associated electronic circuit are not shown here, but lie well within the reach of a person with ordinary skill in the art in terms of the realization thereof.

A similar description applies for the second coupling 11, which comprises a coupling part 23 movable along drive shaft 5 and rotating therewith which can be pressed against toothed wheel 14 under the influence of coils 31 to set the toothed wheel 14 into a rotating movement. Toothed wheel 14 is therefore the second coupling part of second coupling 11. It is here also the case that the control and associated electronics for energizing the coils 31 are not shown here, but lie well within the reach of a person with ordinary skill in the art in terms of the realization thereof.

FIG. 3 shows an alternative embodiment which, as an addition relative to FIGS. 1 and 2, comprises an extra coupling 32. This coupling also comprises a free-running first coupling part 33 which can be set into motion with a second coupling part 34 under the influence of the coils 31 arranged herein with the action of drive shaft 5. Coupling 32 does not however comprise a toothed wheel acting on a counter wheel as the second coupling 11 does, but a drive belt 35. Drive belt 35 is trained round a wheel 36 which, as toothed wheel 15, is fixedly connected to bush 16. Actuating of coupling 11 and actuating of coupling 32 thus results in an oppositely oriented rotation of spray nozzles 2 on the substantially horizontal axis X. It is important here that the second coupling 11 and the extra coupling 32 are not set into operation simultaneously. This is a matter of suitable control of coils 31 to energize the relevant one of the second coupling 11 and the extra coupling 32.

FIG. 4 shows in cross-section a side view of an alternative coupling which is preferably applied in an apparatus according to the present invention. Such a coupling can replace one of the couplings 10, 11 or 32 but can also be applied for each one of these couplings.

As shown in FIG. 4, the magnetic field coupling 43 comprises a first coupling part 38 and a second coupling part 39 with a filling ring 41 therebetween. There is further provided a disc 44 into which are incorporated coils 42. Disc 44 is stationary relative to the surroundings. Drive shaft 5 herein passes through disc 44 and can rotate on the longitudinal axis thereof without co-displacing the disc 44.

Coils 42 incorporated in disc 44 are energized by means of power supply and control cables 37.

In the energized state the coils 42 apply a field which is so strong that the lines of force also run through the first and second coupling parts 38, 39. The first and second coupling parts 38, 39 are thus coupled electromagnetically to each other. The first coupling part 38 is rigidly connected to drive shaft 5, while the second coupling part 39 is bearing mounted around shaft 5. In an electromagnetically coupled situation of the first coupling part and the second coupling part 38 and 39, i.e. in energized state of coils 42, the second coupling part 38 is co-displaced, as a result of the applied magnetic forces, in the rotation movement of the first coupling part 38 which is imposed by drive shaft 5. Toothed wheel 40 is thus driven as a result of the engagement thereon by the second coupling part 39 which is provided on its radial periphery with a toothing.

This configuration has the advantage that the driving takes place in frictionless manner. The magnetic field coupling 43 is therefore not susceptible to wear. Nor can the drive be overloaded, because in such a situation the second coupling part 39 will slip without friction relative to the first coupling part 38. A further advantage of this configuration is that no axial displacement of one of the two coupling parts 38, 39 need take place relative to drive shaft 5, but the diverse components of coupling 43 can remain stationary, at least in longitudinal direction, in respect of drive shaft 5. The alignment of the transmission toward the shaft 8 (see FIGS. 1, 2 and 3) is hereby also considerably simplified.

FIG. 5 shows an alternative embodiment of an apparatus 45 according to the present invention. This embodiment differs in a number of aspects from the foregoing embodiments. A motor shaft 46 is for instance connected directly onto shaft 8 which extends from gearbox 7 into upright tube 24. In the embodiment shown here use is made for the rotation movement of spray nozzle 2 of a worm wheel transmission 47. When the motor is activated and shaft 8 is rotated as a result round the longitudinal direction thereof, the spray nozzles rotate on the horizontal axis. No longitudinal displacement of shaft 8 thus takes place, other than to possibly leave clear or close the outflow opening 20.

Gearbox 7 comprises two couplings in the embodiment shown here. Both are hydraulic or pneumatic. This is a very favourable embodiment, particularly in respect of spaces with possible fire hazard where gases from substances previously transported in the container may constitute a fire hazard, even when magnetic field couplings are used. The metal parts scraping over each other could still generate a spark, particularly when the coupling parts come into contact and when the contact is broken. Such a spark in combination with said gases could have disastrous consequences.

Gearbox 7 comprises two feed lines 48 and 49, which each run to one of the two pneumatic couplings 50 and 51.

Pneumatic couplings 50 and 51 are each formed by a flexible element such as a rubber sleeve 52, 53. When the pressure in pneumatic coupling 51 is increased via line 48, the rubber sleeve 52 of coupling 50 can mutually connect upright tube 24 and the down-shaft. Upright tube 24 is thus co-displaced in a rotation movement round the longitudinal direction of the down-shaft 8 when the motor is energized. When pneumatic coupling 50 is deactivated, only the down-shaft 8 rotates in the energized state of the motor and the spray nozzles 2 rotate only on the horizontal axis. With the pneumatic coupling 50 in actuated state both the down-shaft 8 and upright tube 24 rotate, as already described above, on the coinciding longitudinal axes thereof, so that the worm wheel transmission causes no relative displacement of the toothed wheel relative to the down-shaft. In such a case there is only rotation of the spray nozzles on the vertical axis.

Actuating of the second pneumatic coupling 51, which is configured in similar manner to the above described pneumatic coupling 50, has the effect that upright tube 24 can be held properly stationary, while the down-shaft rotates under the influence of the motor to cause spray nozzles 2 to rotate on the horizontal axis via the worm wheel transmission 47. This pneumatic coupling 51 can however also form a type of slip coupling at less than the full pressure required for coupling, which is also still safe in a fire hazard environment, possibly in contrast to magnetic field couplings or plate couplings etc.

It is also noted here that the embodiment shown in FIG. 5 has another very advantageous aspect. When the motor is deactivated and both couplings are actuated simultaneously, spray nozzles 2 are stopped with certainty. No run-on occurs. In view of the very high pressure of the cleaning fluid—to as much as 240 bar—a cleaning apparatus can, without further measures, have a very long run-on time. This shortcoming is prevented in the configuration of FIG. 5. Position sensors (not shown) can moreover also be arranged, preferably on the spray nozzle itself, to stop the latter at a predetermined desired position. A favourable predetermined position of spray nozzles 2 can be straight downward, so that spray nozzles 2 do not form an obstruction when the whole device 45 is withdrawn again from the container. As shown in FIG. 1, the opening through which the upright tube and the spray nozzles on the outer end thereof must be brought upward is often small. For this reason it is advantageous to direct the spray nozzles upward or downward before the device 45 is withdrawn. Downward orientation of the spray nozzles then has the additional advantage that the spray orifices of the spray nozzles are protected against the situation where they can strike against the edges of the passage on the inside of the container.

The construction shown in FIG. 5 also has the advantage that it can be wholly designed from non-corroding materials, in particular rubber for the couplings and stainless steel for the other components. The configuration of FIG. 5 is hereby eminently suited to use in a wet environment. This is contrast to the other above described embodiment, the magnetic field couplings of which are susceptible to corrosion.

Many alternative and additional embodiments will occur to the skilled person after examination of the foregoing. An additional coupling can thus be associated with the rotation movement on the substantially vertical axis Z so as to produce a rotation in a direction opposite to that associated with the co-action between pinion 12 and toothed wheel 13. Diverse extra couplings can also be provided in gearbox 7 with diverse differing transmission ratios, so that desirable and suitable rotation speeds on each of the individual axes can be freely selected.

The various alternative and additional embodiments not explicitly described here all fall within the scope of the present invention as defined in the appended claims. The present invention is thus not deemed limited to the explicitly described embodiments, but only to the scope defined by the claims including all embodiments not explicitly described, wherein the described embodiments are deemed only as being illustrative of the present invention.

1. Apparatus for cleaning inner walls of a container, comprising:
at least one spray nozzle (2) which is rotatable at least on a first (x) and on a second (z) axis, wherein the first and the second axis enclose an angle;
a drive (4) connectable to the spray nozzle for selective rotation of the spray nozzle (2); and
a transmission (9) between the drive and the spray nozzle,
wherein the transmission comprises at least two couplings (10, 11), each of which can be actuated selectively and each of which is associated with one of the axes.

2. Apparatus as claimed in claim 1, wherein at least one of the couplings comprises two coupling parts and are arranged on a single drive shaft, and at least one coupling part of each of the couplings is displaceable therealong.

3. Apparatus as claimed in claim 1 or 2, wherein at least one of the couplings is a magnetic field coupling.

4. Apparatus as claimed in claim 1, 2 or 3, wherein the first axis is substantially horizontal and the associated coupling is connected via a shaft to the spray nozzle, which shaft comprises a gear rack and is movable up and downward under the influence of the coupling, and wherein the spray nozzle engages the shaft on the gear rack via a toothed wheel.

5. Apparatus as claimed in claim 4, wherein during operation of the apparatus the shaft is located in an outflow opening and when the apparatus is not in operation the shaft can be retracted therefrom under the influence of the coupling.

6. Apparatus as claimed in one or more of the foregoing claims, wherein the second axis is substantially vertical and the associated coupling is connected via a shaft to the spray nozzle, which shaft is rotatable round the longitudinal direction thereof under the influence of the associated coupling.

7. Apparatus as claimed in claim 6, wherein the spray nozzle is arranged in a housing, which housing is connected rigidly to the shaft and is rotatable with the shaft.

8. Apparatus as claimed in claims 4 and 6, wherein the shafts with which the couplings are connected to the spray nozzle form a unit.

9. Apparatus as claimed in one or more of the foregoing claims, wherein the transmission comprises at least one additional coupling which can be selectively actuated and which is associated with one of the axes, which additional coupling is oriented in a direction opposite to that of the coupling associated with the relevant one of the axes.

10. Apparatus as claimed in claim 1, wherein at least one of the couplings is a pneumatic or hydraulic coupling.

11. Apparatus as claimed in any of the foregoing claims, wherein a first of the couplings can be selectively actuated between an upright tube and a shaft extending therethrough, and the other coupling can be selectively actuated to act on the upright tube, and wherein the shaft is coupled to the spray nozzle at the spray nozzle via a transmission placed in the upright tube.
